(19) United States
(12) Patent Application Publication
(10) Pub. No.: US 2024/0272271 A1
(43) Pub. Date: Aug. 15, 2024

(54) Four-Dimensional Polarization Filtering

(71) Applicant: University of Notre Dame du Lac, South Bend, IN (US)

(72) Inventors: Thomas G Pratt, South Bend, IN (US); Luke Saladis, South Bend, IN (US)

(21) Appl. No.: 18/439,375

(22) Filed: Feb. 12, 2024

Related U.S. Application Data
(60) Provisional application No. 63/484,271, filed on Feb. 10, 2023.

(51) Int. Cl. G01S 7/02

(52) U.S. Cl. CPC G01S 7/0231; G01S 7/025

(57) ABSTRACT

A system and method for detecting targets with radar signals are disclosed which include a receiver configured to receive a radar signal and generate a first return vector having four elements representing four channels of a full-polarimetric radar reading, and a four-dimensional polarization filter applied to the first return vector, the four-dimensional polarization filter configured to arrange the first return vector in a column of four elements according to polarimetric components associated with of respective transmit/receive channels, take an inner product of a selected vector with the column, derive a projection coefficient by dividing the inner product by a magnitude of the selected vector, and produce an output by subtracting a product of the projection coefficient and the selected vector from the column.

### CROSS-REFERENCE TO RELATED APPLICATIONS

This application claims priority to U.S. Provisional Application No. 63/484,271 filed on 10 Feb. 2023 and entitled “4D Polarization Filtering” and is herein incorporated by reference in its entirety.

### GOVERNMENT SUPPORT

This invention was made with government support under N00014-18-1-2134 awarded by the U.S. Office of Naval Research, Code 31. The government has certain rights in the invention.

### TECHNICAL FIELD

The present description relates to polarization filtering of radar returns to enhance target detection, characterization, and identification.

### BACKGROUND

A conventional polarization filter (CPF), also known as a single notch polarization filter (SNPF), allows a specified polarization component to be removed from a signal. This operation essentially involves a dot product between the two-dimensional polarized signal vector and a two-dimensional polarization vector corresponding to the polarization state to be suppressed. The resulting dot product effectively removes the designated polarization. This procedure is necessarily limited to a single polarization state, as it consumes the sole degree of freedom associated with this representation.

The polarization state to be filtered is sometimes associated with an interference signal or clutter, or a target that obfuscates detection of a weaker target return. These can often be measured with minimal impact from the desired return. A related issue to the use of a polarization filter is the issue of simultaneously attenuating the desired signal response. Polarization filters can therefore be designed to optimize the signal to interference ratio, for example with minimum mean square approaches (see Stapor, for example).

In other cases, knowledge of the desired signal polarization may be available. Null phase shift polarization filter (NPSPF) uses a combination of vector translations and filtering to minimize distortion in a selected (desired) polarization while completely removing another. Oblique projection polarization filter (OPPF) accomplishes complete removal with minimum distortion while loosening the conditions for success found in the NPSPF. These filters may require knowledge of the desired signal polarization as opposed to only the interference polarization. The precision of such knowledge is also a useful aspect of filtering performance.

Some combination of all of these advances in polarization filtering with methods of finding the necessary polarizations can be found in the area of adaptive polarization filtering. Generally, foreknowledge of clutter statistics or interference signal parameters is still needed to a greater or lesser degree, but the methods will still only be able to achieve a single ideal suppression, as all of these operations take place in two-dimensional polarization space.

As such, there is an identifiable desire for improvements in the features in or associated with polarization filtering, which becomes feasible when radar returns associated with multiple transmit polarizations (typically orthogonally-polarized) are measured.

### SUMMARY

A system and method for detecting targets with radar signals are disclosed which include the following: a transmitter configured to transmit orthogonally-polarized incident radar signals; a receiver configured to receive orthogonally-polarized radar signal components and that generates a first return vector having four elements representing four channels of a full-polarimetric radar reading; and a four-dimensional polarization filter applied to the first return vector to suppress undesired signal energy. The four-dimensional polarization filter is configured to arrange the first return vector in a column of four elements according to polarimetric components associated with the respective transmit/receive channels, take an inner product of a selected vector with the column, derive a projection coefficient by dividing the inner product by a magnitude of the selected vector, and produce an output by subtracting a product of the projection coefficient and the selected vector from the column. This process can be repeated to effect three suppression operations, each using a different polarization filter that is dependent upon the previous polarization filters.

In implementations, the selected vectors are estimated from an undesired interference signal or clutter that impact detection performance.

In implementations, the column is indexed by either time (or equivalently range).

In implementation, the four channels include a HH channel for horizontal transmit and horizontal receive, a VV channel for vertical transmit and vertical receive, a HV channel for horizontal transmit and vertical receive and a VH channel for vertical transmit and horizontal receive.

In implementations, the receiver includes at least one matched filter configured to examine the received radar signal against the transmitted radar signals to generate the first return vector.

### BRIEF DESCRIPTION OF THE DRAWINGS

FIG. 1 is block diagram illustrating an exemplary radar system.

FIG. 2 is a flowchart illustrating an exemplary process of filtering out an interference signal from radar readings using a polarization filter.

FIG. 3 is a flowchart illustrating an exemplary process of filtering out an interference signal from radar readings using a four-dimensional polarization filter.

FIG. 4 is a block diagram of a radar transceiving and processing system for implementing the processes shown in FIGS. 2 and 3.

FIG. 5 is a simulation result of an environment with and without a masking object at index 100.

FIG. 6 is a simulation result of an environment with and without GSPF applied at index 100.

FIG. 7 shows a simulation comparing a GSPF result with an ideal result.

FIG. 8 shows a simulation comparing GSPF and CPF results.

FIG. 9 shows a simulation of an environment with or without masking object at index 100 and 122.

FIG. 10 shows a simulation of an environment with object at index 100 and 122 and

with GSPF filtering.

FIG. 11 shows a simulation of an environment without object at index 100 and 122 and with GSPF filtering.

FIG. 12 shows a simulation of an environment without object at index 100 and 122 and with a comparison between CPF and GSPF filtering.

FIGS. 13A and 13B illustrate an experimental radar system for demonstrating the capability of a four-dimensional GSPF.

FIG. 14 shows measurements with the presents of all the targets or each target individually.

FIG. 15 shows measurements of all the targets with a GSPF applied to reveal target T2.

FIG. 16 shows a comparison between the GSPF measurement and an ideal measurement.

FIG. 17 shows a comparison between the GSPF measurement and a CPF measurement.

FIG. 18 shows a comparison between another GSPF measurement and the ideal measurement.

FIG. 19 shows a comparison between the GSPF measurement using no prior polarization knowledge and the ideal target T2 measurement.

FIG. 20 shows a comparison between GSPF and CPFs results both without using prior polarization knowledge.

### DETAILED DESCRIPTION

The present disclosure describes a full-polarized radar system employing a four-dimensional polarization filter with capability to filter out interference echo signals.

The following description of example methods and apparatus is not intended to limit the scope of the description to the precise form or forms detailed herein. Instead, the following description is intended to be illustrative so that others may follow its teachings.

A radar system creates polarized waves using an antenna that is designed to transmit and receive electromagnetic (EM) waves of a specific polarization. Antennas come in many forms, including horns, waveguides, dipoles and patches. In each case, the electric and mechanical properties of the antenna are such that the transmitted wave is almost purely polarized with a specific design polarization. In a simple radar system, the same antenna is often configured so that it is matched to the same polarization on reception (when an EM wave is incident upon it).

Control of signal polarization is possible by transmitting a signal coherently through two orthogonally-polarized antennas (basis polarizations) and controlling the relative amplitude and the relative phase between the signals. The two most common basis polarizations are horizontal linear or H, and vertical linear or V. Circular polarizations are also in use for some applications, e.g., weather radars. Their basis components are denoted by R for Right Hand Circular and L for Left Hand Circular. A circular polarized signal can be achieved using an H/V basis by feeding the H and V parts of the antenna simultaneously, with the same signal at equal strength and with a 90° phase difference.

In more complex radar systems, the antenna may be designed to enable simultaneous transmission and signal reception at more than one polarization. Signal processing at the receiver can be utilized to separate the responses from the at-least two transmitted signals.

The radar antenna may be designed to receive the different polarization components of the EM wave simultaneously. For example, an H and V polarization basis can be used at the receiver to receive the two orthogonal components of the incoming wave.

As one example, denoting the transmit and receive polarizations by a pair of symbols, a radar system using H and V linear polarizations can thus have the following channels:
HH—for horizontal transmit and horizontal receive,
VV—for vertical transmit and vertical receive,
HV—for horizontal transmit and vertical receive, and
VH—for vertical transmit and horizontal receive.

The first two of these polarization combinations are referred to as co-polarized, because the transmit antenna component and the received antenna component have the same polarization. The last two combinations are referred to as cross-polarized because the transmit antenna polarization and the receive antenna polarization are orthogonal to one another. A radar system can have different levels of polarization complexity:
single polarized—HH or VV or HV or VH
dual polarized—HH and HV, VV and VH, or HH and VV
four or full polarizations—HH, VV, HV, and VH

A full-polarization (i.e. polarimetric) radar uses these four responses, and measures the phase difference between the channels as well as the magnitudes. Some dual polarized radars also measure the phase difference between channels, as this phase plays a role in polarimetric information extraction.

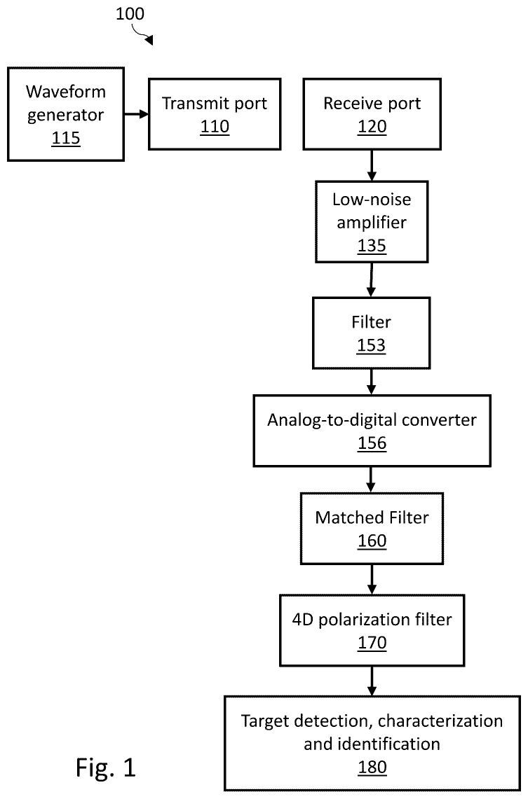

FIG. 1 is block diagram illustrating an exemplary radar system 100 that includes a transmit port 110, a waveform generator 115, a receive port 120, a low-noise amplifier 135, a filter 153, an analog-to-digital converter 156, a matched filter 160, a four-dimensional filter 170 and signal processing for target detection, characterization, and identification 180.

In implementations, transmit port 110 transmits signals generated by waveform generator 115 in the form of EM radiation in space. Receive port 120 receives back reflected signals. A target within a range of the radar system 100 can be detected, characterized, and identified when a transmitted signal reflected by the target is received, and the returns are processed using signal processing resources.

In implementations, waveform generator 115 generates EM waves that are amplified before being transmitted through an antenna.

Polarization is a property of transverse waves that refers to the geometric orientation of the oscillations of the corresponding wave in the plane transverse to the signal propagation direction. Full-polarization radar refer to the use of orthogonally-polarized radar transmit signals.

In implementation, the received echo signals are amplified by a low-noise amplifier 135, filtered by filter 153 and converted to digital signals by analog-to-digital converter 156 before the signals are converted to complex baseband representations. This may be accomplished through heterodyne processing, homodyname processing, or direct wideband sampling.

In implementations, the baseband signal is applied to matched filter 160, where the matched filter is formed from the transmitted signal, and where the output provides a range profile of targets in the environment. In the case of multiple transmit signals and multiple receive channels, matched filtering for each transmit/receiver pair would be performed.

Referring again to FIG. 1, in implementations of full-polarization radar operation, the radar system 100 employs a four-dimensional polarization filter 170 to the outputs of the matched filtering 160 before performing target detection, characterization, and identification 180.

In the case of full-polarization radar operation, a target's reflection of orthogonally-polarized incident radar waves is represented using a scattering matrix. This matrix has four entries and can be vectorized into a four-dimensional entity. Moving to a four-dimensional representation for polarimetric suppression of radar targets necessarily leads to a different framework for radar signal processing. But these slight changes provide benefits in the use of polarization filtering. Most significantly, the framework supports polarization filtering with up to three nulls. Second, the four-dimensional filtering framework enables the estimation of polarization information directly from matched filter outputs.

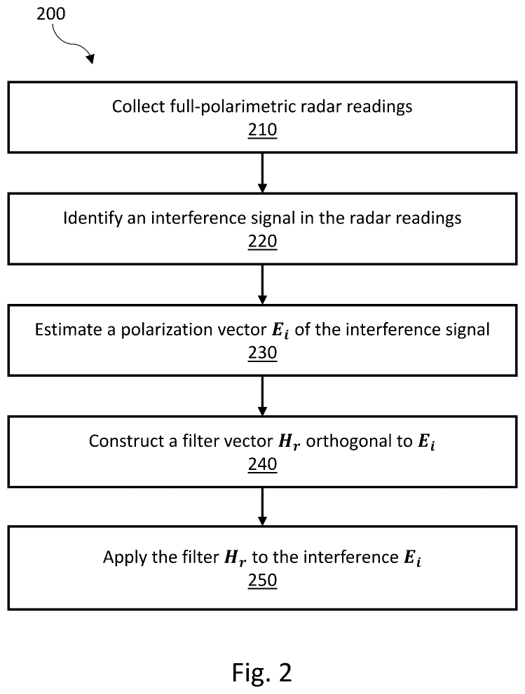

FIG. 2 is a flowchart illustrating an exemplary process 200 of filtering out an interference signal from radar readings using a polarization filter. The filtering process 200 begins with collecting full-polarimetric radar readings in block 210. An interference signal in the radar readings is identified in block 220. Then a polarization vector Eᵢ of the interference signal is estimated in block 230.

The estimated polarization vector, Eᵢ(n), of an interference signal at sample n can be represented polarimetrically as

$${E}_{i} ( n ) = [ \begin{matrix}{E}_{i x} ( n ) \\ {E}_{i y} ( n )\end{matrix} ] = [ \begin{matrix}{E}_{i} cos {ε}_{i} exp ( j {ω}_{i} n ) \\ {E}_{i} sin {ε}_{i} exp [ j ( {ω}_{i} n + {δ}_{i} ) ]\end{matrix} ] \qquad ( Eq . 1 )$$

where x and y are the orthogonal basis of the antenna plane. As an example, x represents the horizontal plane and y represents the vertical plane.

Referring again to FIG. 2, with the knowledge of the interference signal, a filter vector, Hᵣ, that is orthogonal to the interference vector Eᵢ, can be constructed in block 240:

$${H}_{r} = [ \begin{matrix}{H}_{r} cos {ε}_{r} \\ {H}_{i} sin {ε}_{r} exp j {δ}_{r}\end{matrix} ] \qquad ( Eq . 2 )$$

The filter Hᵣ is then applied to the interference Eᵢ in block 250:

$${H}_{r}^{H} {E}_{i} ( n ) = \text{} {H}_{r} {E}_{i} cos {ε}_{r} cos {ε}_{i} exp ( j {ω}_{i} n ) + {H}_{r} {E}_{i} sin {ε}_{i} sin {ε}_{r} exp [ j ( {ω}_{i} n + {δ}_{i} - {δ}_{r} ) ] \qquad ( Eq . 3 )$$

$$simplifying$$

$${H}_{r}^{H} {E}_{i} ( n ) = \text{} {H}_{r} {E}_{i} exp ( j {ω}_{i} n ) ( cos {ε}_{r} cos {ε}_{i} + sin {ε}_{i} sin {ε}_{r} exp [ j ( {δ}_{i} - {δ}_{r} ) ] ) \qquad ( Eq . 4 )$$

$$If {δ}_{r} - {δ}_{i} = π \qquad ( Eq . 5 )$$

$$then exp [ j ( {δ}_{i} - {δ}_{r} ) ] = - 1 \qquad ( Eq . 6 )$$

Then the remainder can be described as

$${H}_{R} {E}_{i} exp ( j {ω}_{i} n ) ( cos {ε}_{r} cos {ε}_{i} - sin {ε}_{i} sin {ε}_{r} ) \qquad ( Eq . 7 )$$

Using the identity

$$cos ( u \pm v ) = cos ( u ) cos ( v ) ∓ sin ( u ) sin ( v ) ) \qquad ( Eq . 8 )$$

Which will be zero when the arguments add to

$$\frac{π}{2} .$$

This provides the final condition that

$${ε}_{r} - {ε}_{i} = \frac{π}{2} \qquad ( Eq . 9 )$$

For all other polarizations distinct from Eᵢ, namely Eₛ at the output of the filter they will be of the form

$${H}_{r}^{H} {E}_{s} ( n ) = \text{} {H}_{r} {E}_{s} exp ( j {ω}_{s} n ) ( cos {ε}_{r} cos {ε}_{s} + sin {ε}_{s} sin {ε}_{r} exp [ j ( {δ}_{s} - {δ}_{r} ) ] ) \qquad ( Eq . 10 )$$

with the distortion that this implies.

More generally the filter (Hᵣ) is a vector orthogonal to the vector of the interference signal (Eᵢ), so multiplying the signal vector by Hᵣ^{H} will create a scaler with the component of the signal vector equal to Eᵢ eliminated.

In a dual polarized radar system, full polarization radar readings can be filtered by polarization filtering. Although two dimensions multiplying with a vector orthogonal to the interference can eliminates the interference completely, this operation also reduces a vector to a scaler.

In another implementation, both of the dual orthogonal transmission antennas transmit continuous linear frequency modulated (LFM) waveforms at any given instance. In an example of a simple phase coded situation, a transmission cycle with N samples has a two cycle form of

$$X = [ \begin{matrix}{x}_{x} ( n ) & {x}_{x} ( n + N ) \\ {x}_{y} ( n ) & - {x}_{y} ( n + N )\end{matrix} ] \qquad ( Eq . 11 )$$

Then equations representing the actual reception on the dual orthogonal receive antenna over two transmission cycle periods will be

$$\begin{matrix}{a}_{11} = {x}_{x} ( n ) * {s}_{x x} ( n ) + {x}_{y} ( n ) * {s}_{y x} ( n ) \\ {a}_{12} = {x}_{x} ( n + N ) * {s}_{x x} ( n + N ) - {x}_{y} ( n + N ) * {s}_{y x} ( n + N ) \\ {a}_{21} = {x}_{x} ( n ) * {s}_{x y} ( n ) + {x}_{y} ( n ) * {s}_{y y} ( n ) \\ {a}_{22} = {x}_{x} ( n + N ) * {s}_{x y} ( n + N ) - {x}_{y} ( n + N ) * {s}_{y y} ( n + N )\end{matrix} \qquad ( Eq . 12 )$$

Here α₁₁ is the received signal on the x basis antenna for the first period; α₁₂ is the same antenna over the second period. A similar breakdown in the y basis for α₂₁ and α₂₂.

These four signals can be arranged in matrix for

$$A = [ \begin{matrix}{a}_{11} ( n ) & {a}_{12} ( n ) \\ {a}_{21} ( n ) & {a}_{22} ( n )\end{matrix} ] \qquad ( Eq . 13 )$$

The above Eq. 13 can be used in following equation

$$R = \frac{1}{2} A {H}_{2} \qquad ( Eq . 14 )$$

where R is the matrix of returns (the channels coefficients convolved with a transmit wave), and H₂ is a 2×2 Hadamard matrix

$${H}_{2} = [ \begin{matrix}1 & 1 \\ 1 & - 1\end{matrix} ] \qquad ( Eq . 15 )$$

If the channel coefficients are stable over two periods, then the result of Eq. 13 produces the channels

$$\begin{matrix}{r}_{x x} = {x}_{x} ( n ) * {s}_{x x} ( n ) \\ {r}_{x y} = {x}_{x} ( n + N ) * {s}_{x y} ( n ) \\ {r}_{y x} = {x}_{y} ( n ) * {s}_{y x} ( n ) \\ {r}_{y y} = {x}_{y} ( n ) * {s}_{y y} ( n )\end{matrix} \qquad ( Eq . 16 )$$

which is the desired result.

This resolves radar reflectors whose polarimetric response can be modeled with a scattering matrix. This creates the four dimensional return vectors that can then be used for four dimensional processing.

A further distinction needs to be made between four dimensional polarization filtering and two dimensional. In two dimensional polarization filtering whether the polarized signal is the reflection off of a target or clutter or is a signal different from the transmitted signal, perhaps something like jamming, they can both be described by their two dimensional polarized signal vector. In four dimensions this is not the case. A reflector has four complex values associated with it that can be recovered with a process like the one just described. An independent signal will not have a four dimensional response. To see how this would be take an independent signal whose polarized response can be represented by

$${E}_{i} ( n ) = [ \begin{matrix}{E}_{i x} ( n ) \\ {E}_{i y} ( n )\end{matrix} ] \qquad ( Eq . 17 )$$

This would result in

$$\begin{matrix}{r}_{x x} = \frac{1}{2} ( {E}_{i x} ( n ) + {E}_{i x} ( n + N ) ) \\ {r}_{x y} = \frac{1}{2} ( {E}_{i y} ( n ) + {E}_{i y} ( n + N ) ) \\ {r}_{y x} = \frac{1}{2} ( {E}_{i x} ( n ) - {E}_{i x} ( n + N ) ) \\ {r}_{y y} = \frac{1}{2} ( {E}_{i y} ( n ) - {E}_{i y} ( n + N ) )\end{matrix} \qquad ( Eq . 18 )$$

For signals that are polarimetrically stable over the measurement period this results in

$$\begin{matrix}{r}_{x x} = {E}_{i x} ( n ) \\ {r}_{x y} = {E}_{i y} ( n ) \\ {r}_{y x} = 0 \\ {r}_{y y} = 0\end{matrix} \qquad ( Eq . 19 )$$

This means that the dimension of the signal space in these readings is still two dimensional. But this signal space is still embedded in the four dimensional polarization space of the returns. Once practical effect of this situation is that is two signal polarizations are removed all independent signals will be. On the other hand a third filter can still be created to remove clutter from the returns.

A related issue to the dimensionality of independent signals, is that of the attenuation of unknown polarizations. If the relation between signal or target polarizations are uncorrelated and random then in a two dimensional filtering space any orthogonal filter that eliminates a designated polarization can be expected to eliminate half the power of the remaining polarized objects in the environment. Moving to four dimensions this figure becomes one quarter. The reduction in expected attenuation aids in finding polarizations because eliminating a given polarization is less likely to make an arbitrary target undetectable. This may be a useful point when taking filtering coefficients directly from matched filter readings as illustrated in FIG. 2.

In implementations, four-dimensional radar polarization filter can be applied in either range of time. For a given radar transmission waveform x, the received signal on the four channels that comprise a full polarization radar system will be the convolution of the waveform and the physical environment. The transmission can be seen in discrete time as

$$x = {[ {x}_{0} {x}_{1} … {x}_{N} ]}^{T} \qquad ( Eq . 20 )$$

And the reflection coefficients of the channel as

$$a = {[ {a}_{0} {a}_{1} … {a}_{M} ]}^{T} \qquad ( Eq . 21 )$$

Then for a particular time a given channels received value will be

$${r}_{{t}_{k}} = \begin{matrix}{r}_{a} ( {t}_{k} ) = {a}_{0} {x}_{L} + {a}_{1} {x}_{( L + 1 )} + \\ {r}_{b} ( {t}_{k} ) = {b}_{0} {x}_{L} + {b}_{1} {x}_{( L + 1 )} + \\ {r}_{c} ( {t}_{k} ) = {c}_{0} {x}_{L} + {c}_{1} {x}_{( L + 1 )} + \\ {r}_{d} ( {t}_{k} ) = {d}_{0} {x}_{L} + {d}_{1} {x}_{( L + 1 )} +\end{matrix} \qquad ( Eq . 22 )$$

When a matched filter is applied then the index of the channels become range

$${r}_{{d}_{k}} = \begin{matrix}{r}_{a} ( {d}_{k} ) = {a}_{0} {ρ}_{L} + {a}_{1} {ρ}_{( L + 1 )} + \\ {r}_{b} ( {d}_{k} ) = {b}_{0} {ρ}_{L} + {b}_{1} {ρ}_{( L + 1 )} + \\ {r}_{c} ( {d}_{k} ) = {c}_{0} {ρ}_{L} + {c}_{1} {ρ}_{( L + 1 )} + \\ {r}_{d} ( {d}_{k} ) = {d}_{0} {ρ}_{L} + {d}_{1} {ρ}_{( L + 1 )} +\end{matrix} \qquad ( Eq . 23 )$$

Where the p's are the matched filter coefficient for the particular target at the distance dk. If the polarization to be filtered corresponds to the values

$${p}_{0} = \begin{matrix}{a}_{0} \\ {b}_{0} \\ {c}_{0} \\ {d}_{0}\end{matrix} \qquad ( Eq . 24 )$$

Then the filter output at a particular time would be

$${y}_{{t}_{k}} = {r}_{{t}_{k}} - \frac{( {p}_{0}^{H} {r}_{{t}_{k}} )}{( {p}_{0}^{H} {p}_{0} )} {p}_{0} \qquad ( Eq . 25 )$$

$$here$$

$$\frac{( {p}_{0}^{H} {r}_{{t}_{k}} )}{( {p}_{0}^{H} {p}_{0} )} \approx \frac{( {\vert {a}_{0} \vert}^{2} + {\vert {b}_{0} \vert}^{2} + {\vert {c}_{0} \vert}^{2} + {\vert {d}_{0} \vert}^{2} ) {x}_{L}}{( {\vert {a}_{0} \vert}^{2} + {\vert {b}_{0} \vert}^{2} + {\vert {c}_{0} \vert}^{2} + {\vert {d}_{0} \vert}^{2} )}$$

where the relations are approximate because there will be smaller terms included that are proportional to the correlation between the polarization being filtered and the other polarizations in the signal. Then

$${y}_{{t}_{k}} \approx {r}_{{t}_{k}} - {x}_{L} {p}_{0} \approx \begin{matrix}{y}_{a} ( {t}_{k} ) \approx {a}_{0} {x}_{L} - {a}_{0} {x}_{L} + {a}_{1} {x}_{( L + 1 )} + … \\ {y}_{b} ( {t}_{k} ) \approx {b}_{0} {x}_{L} - {b}_{0} {x}_{L} + {b}_{1} {x}_{( L + 1 )} + … \\ {y}_{c} ( {t}_{k} ) \approx {c}_{0} {x}_{L} - {c}_{0} {x}_{L} + {c}_{1} {x}_{( L + 1 )} + … \\ {y}_{d} ( {t}_{k} ) \approx {d}_{0} {x}_{L} - {d}_{0} {x}_{L} + {d}_{1} {x}_{( L + 1 )} + …\end{matrix} \qquad ( Eq . 26 )$$

Or for a particular distance it would be

$${y}_{{d}_{k}} = {r}_{{d}_{k}} - \frac{( {p}_{0}^{H} {r}_{{d}_{k}} )}{( {p}_{0}^{H} {p}_{0} )} {p}_{0} \qquad ( Eq . 27 )$$

$$here$$

$$\frac{( {p}_{0}^{H} {r}_{{d}_{k}} )}{( {p}_{0}^{H} {p}_{0} )} \approx \frac{( {\vert {a}_{0} \vert}^{2} + {\vert {b}_{0} \vert}^{2} + {\vert {c}_{0} \vert}^{2} + {\vert {d}_{0} \vert}^{2} ) {ρ}_{L}}{( {\vert {a}_{0} \vert}^{2} + {\vert {b}_{0} \vert}^{2} + {\vert {c}_{0} \vert}^{2} + {\vert {d}_{0} \vert}^{2} )}$$

Again, the relation is approximate because of the additional terms, also proportional to the correlation between the polarizations. Then we can again see that

$${y}_{{d}_{k}} \approx {r}_{{d}_{k}} - {ρ}_{L} {p}_{0} \approx \begin{matrix}{y}_{a} ( {d}_{k} ) \approx {a}_{0} {ρ}_{L} - {a}_{0} {ρ}_{L} + {a}_{1} {ρ}_{( L + 1 )} + … \\ {y}_{b} ( {d}_{k} ) \approx {b}_{0} {ρ}_{L} - {b}_{0} {ρ}_{L} + {b}_{1} {ρ}_{( L + 1 )} + … \\ {y}_{c} ( {d}_{k} ) \approx {c}_{0} {ρ}_{L} - {c}_{0} {ρ}_{L} + {c}_{1} {ρ}_{( L + 1 )} + … \\ {y}_{d} ( {d}_{k} ) \approx {d}_{0} {ρ}_{L} - {d}_{0} {ρ}_{L} + {d}_{1} {ρ}_{( L + 1 )} + …\end{matrix} \qquad ( Eq . 28 )$$

With both indices the channel relationship is preserved so the filter can be applied directly. That is the polarization being filtered will be completely removed, and the additional terms are due to correlation between the polarizations whose relationships do not change when matched filtering is applied.

When filtering moves to four dimensions there is an extra consideration in forming the filter. Whereas with two dimensions multiplying with a vector orthogonal to the interference or clutter Et eliminates the interference completely. This operation also reduces a vector to a scalar. To accommodate making up to four vectors mutually orthogonal to each other, recourse can be made to the linear algebraic Gram-Schmidt method.

Gram-Schmidt polarization filtering (GSPF) is a technique used in signal processing to remove the polarization component of a signal. The Gram-Schmidt process is a mathematical algorithm that takes a set of vectors and produces an orthonormal basis for the subspace they span. The polarization filtering technique uses this algorithm to create a new basis for the polarization subspace of a signal, which can then be removed from the original signal.

An observation to be immediately made is that the condition to remove multiple polarizations is linear independence between them. If this condition is met a more specific look at the process can be made.

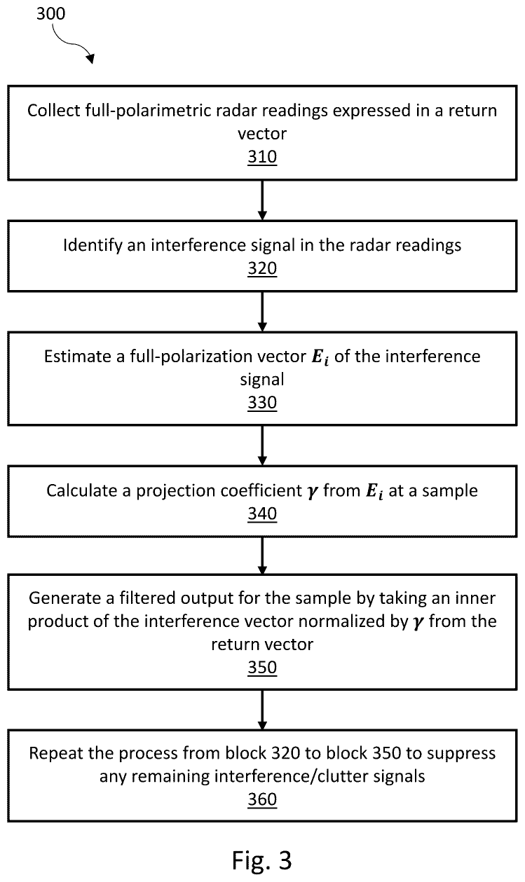

FIG. 3 is a flowchart illustrating an exemplary process 300 of filtering out an interference signal from radar readings using a four-dimensional polarization filter. The filtering process 300 begins with collecting full-polarimetric radar readings in block 310. A result of the full-polarimetric radar reading in basis x and y at sample n can be expressed by a return vector

$$r ( n ) = {[ \begin{matrix}{r}_{x x} ( n ) & {r}_{x y} ( n ) & {r}_{y x} ( n ) & {r}_{y y} ( n )\end{matrix} ]}^{T} \qquad ( Eq . 29 )$$

When the signal is fully polarized, that is unchanging from some duration, this can be simplified to

$$r ( n ) = {R ( n ) [ \begin{matrix}{r}_{x x} & {r}_{x y} & {r}_{y x} & {r}_{yy}\end{matrix} ]}^{T} \qquad ( Eq . 30 )$$

here R(n) is the unpolarized signal, and the relationship between the channels is constant.

In block 320, an interference signal in the radar readings is identified. Then a full-polarization vector Eᵢ of the interference signal is estimated in block 330.

Now if a polarization is identified to be removed Eᵢ, and the remainder of the signal as s(n)=r(n)−Eᵢ(n), the following is obtained

$$r ( n ) = {E}_{i} ( n ) [ \begin{matrix}{E}_{i x x} \\ {E}_{i x y} \\ {E}_{i y x} \\ {E}_{i y y}\end{matrix} ] + S ( n ) [ \begin{matrix}{s}_{xx} \\ {s}_{x y} \\ {s}_{y x} \\ {s}_{y y}\end{matrix} ] \qquad ( Eq . 31 )$$

If the interference vector [Eᵢₓₓ E_{ixy} E_{iyx} E_{iyy}]^{T} is known, then following the Gram-Schmidt procedure, the component of all vectors that align with the above interference vector can be eliminated.

In block 340, a projection coefficient γ is calculated at a particular sample n

$$γ ( n ) = \frac{1}{{\vert {E}_{i} \vert}^{2}} [ \begin{matrix}{E}_{i x x}^{*} & {E}_{i x y}^{*} & {E}_{i y x}^{*} & {E}_{iyy}^{*}\end{matrix} ] [ \begin{matrix}{r}_{x x} ( n ) \\ {r}_{x y} ( n ) \\ {r}_{y x} ( n ) \\ {r}_{y y} ( n )\end{matrix} ] \qquad ( Eq . 32 )$$

In implementation, a four-dimensional polarization filter is configured to arrange the return vector in a column of four elements according to polarimetric positions of respective channels, and derive a projection coefficient by dividing the inner product by a magnitude of the interference vector, Eᵢ, as indicated in Eq. 32.

In block 350, a filtered output for the sample n is generated by taking an inner product of the interference vector, Eᵢ, normalized by γ from the return vector as expressed in below equation,

$$h ( n ) = r ( n ) - γ ( n ) [ \begin{matrix}{E}_{i x x} \\ {E}_{i x y} \\ {E}_{i y x} \\ {E}_{i y y}\end{matrix} ] \qquad ( Eq . 33 )$$

Eq. 33 indicates that the filter output is produced by subtracting a product of the projection coefficient and the selected vector from the column of the return vector.

The above Gram-Schmidt process in blocks 320 and 350 can be applied repeatedly in block 360 to suppress any remaining interference and/or clutter signals.

To see the effects of the filtering process 300, consider the signal which is the sum of the polarized signal to be removed and the remaining unknown polarized signal.

$$r ( n ) = α {E}_{i} ( n ) [ \begin{matrix}{E}_{i x x} \\ {E}_{i x y} \\ {E}_{i y x} \\ {E}_{i y y}\end{matrix} ] - β S ( n ) [ \begin{matrix}{s}_{x x} \\ {s}_{x y} \\ {s}_{y x} \\ {s}_{y y}\end{matrix} ] \qquad ( Eq . 34 )$$

where α and β are independent arbitrary coefficients multiplied to the polarization to be filtered and the other polarizations in the signal.

In Eq. 34, the idea is that the two quantities can vary relative to each other between filtering instances without any change to the filter's effectiveness.

The particulars of the signal modulating the polarization such as frequency and amplitude are not relevant. Also any additional distortion represented by the coefficients α and β can be dealt with and there is no requirement for stability in the non-interference polarization. Since the Gram-Schmidt process is linear, the component effects can be examined separately.

In an implementation, a first step in the process is to identify the polarization to be removed. Here this means knowledge of interference vector Eᵢ(nₒ). The interference is chosen for a particular sample to form the filter coefficients. The ability to use matched filter outputs to form estimates is useful. The important part may be the polarized portion, so the particular sample containing that polarized portion is irrelevant as the unpolarized portion will divide out.

Next the projection coefficient of the interference portion, γ, is calculated

$${γ}_{E} ( n ) = {\frac{1}{{\vert {E}_{i} \vert}^{2}} [ \begin{matrix}{E}_{i x x} \\ {E}_{i x y} \\ {E}_{i y x} \\ {E}_{i y y}\end{matrix} ]}^{H} α {E}_{i} ( n ) [ \begin{matrix}{E}_{i x x} \\ {E}_{i x y} \\ {E}_{i y x} \\ {E}_{i y y}\end{matrix} ] = α {E}_{i} ( n ) \qquad ( Eq . 35 )$$

Similarly, projection coefficient of the untargeted portion is calculated as following

$${γ}_{S} ( n ) = {\frac{1}{{\vert {E}_{i} \vert}^{2}} [ \begin{matrix}{E}_{i x x} \\ {E}_{i x y} \\ {E}_{i y x} \\ {E}_{i y y}\end{matrix} ]}^{H} β S ( n ) [ \begin{matrix}{s}_{xx} \\ {s}_{x y} \\ {s}_{y x} \\ {s}_{y y}\end{matrix} ] = β S ( n ) \frac{\vert S ( n ) \vert \vert {E}_{i} ( n ) \vert cos ( θ )}{{\vert {E}_{i} \vert}^{2}} \qquad ( Eq . 36 )$$

where θ is an angle between S and Eᵢ.

With Eqs. 35 and 36, a next step is to calculate the filter output, which is done by component first. Keeping the previous order and starting with the interference

$$h ( n ) = α {E}_{i} ( n ) [ \begin{matrix}{E}_{i x x} \\ {E}_{i x y} \\ {E}_{i y x} \\ {E}_{i y y}\end{matrix} ] + β S ( n ) [ \begin{matrix}{s}_{x x} \\ {s}_{x y} \\ {s}_{y x} \\ {s}_{y y}\end{matrix} ] - ( {γ}_{E} ( n ) + {γ}_{S} ( n ) ) [ \begin{matrix}{E}_{i x x} \\ {E}_{i x y} \\ {E}_{i y x} \\ {E}_{i y y}\end{matrix} ] = β S ( n ) ( [ \begin{matrix}{s}_{x x} \\ {s}_{x y} \\ {s}_{y x} \\ {s}_{y y}\end{matrix} ] - \frac{\vert S ( n ) \vert \vert {E}_{i} ( n ) \vert cos ( θ )}{{\vert {E}_{i} \vert}^{2}} [ \begin{matrix}{E}_{i x x} \\ {E}_{i x y} \\ {E}_{i y x} \\ {E}_{i y y}\end{matrix} ] ) \qquad ( Eq . 37 )$$

So, the final result has eliminated the signal associated with the interference polarization. This is accomplished independent of the modulation of the signals being processed. The output also retains all channels and other modulations unaltered. However, there are still distortions in the remaining signal.

In another implementation, a projection filtering can be applied on radar returns. Assume a polarization to be removed from the radar returns is p₀. If there is a polarization, p₁, to be preserved, that is leave completely unaltered by the filter, this can be accomplished through projection filtering. The simplest way to achieve this is to construct the matrix

$$\begin{matrix}F = [ \begin{matrix}{p}_{0} & {p}_{1} & {e}_{0} & {e}_{1}\end{matrix} ] \\ where \\ {e}_{0} = {[ \begin{matrix}1 & 0 & 0 & 0\end{matrix} ]}^{T} \\ {e}_{1} = {[ \begin{matrix}0 & 1 & 0 & 0\end{matrix} ]}^{T}\end{matrix} \qquad ( Eq . 38 )$$

Then in either time or distance, but taking time as the example, the filter can be applied through

$$\begin{matrix}{g}_{0} \\ {g}_{1} \\ {g}_{2} \\ {g}_{3}\end{matrix} = {F}^{- 1} {r}_{{t}_{k}} \qquad ( Eq . 39 )$$

And finally, the projection filter results are given by

$${y}_{{t}_{k}} = {g}_{1} {p}_{1} + {g}_{2} {e}_{0} + {g}_{3} {e}_{1} \qquad ( Eq . 40 )$$

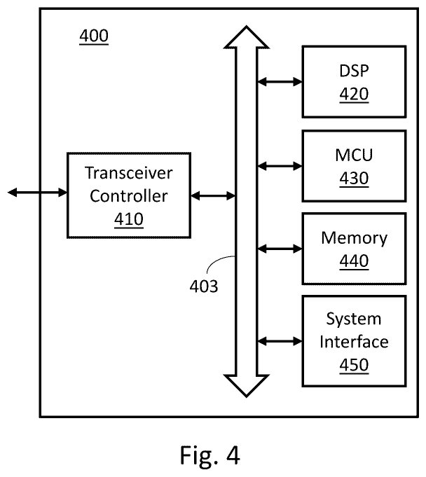

FIG. 4 is a block diagram of a radar transceiving and processing system 400 for implementing the processes shown in FIGS. 2 and 3. As an example, the radar transceiving and processing system 400 includes a transceiver controller 410 coupled, through a bus 403, to a digital signal processor 420, a microcontroller unit 430, a memory 440 and a system interface 450. The transceiver controller 410 controls the transmission and receiving of multiple polarization radar signals. Data collected by the transceiver controller 410 is passed to digital signal processor 420 and microcontroller unit 430 for filtering and data processing depicted in FIGS. 2 and 3. Programmed instructions for performing the filtering and data processing are stored in memory 440. Processed return data is outputted through system interface 450.

In other implementations, the filtering and processing functions depicted in FIGS. 2 and 3 can be performed by hardware constructed from field programmable gate array (FPGA) or application-specific integrated circuit (ASIC). Such hardware implementation has the advantage of processing speed but may not have the flexibility of a software implementation.

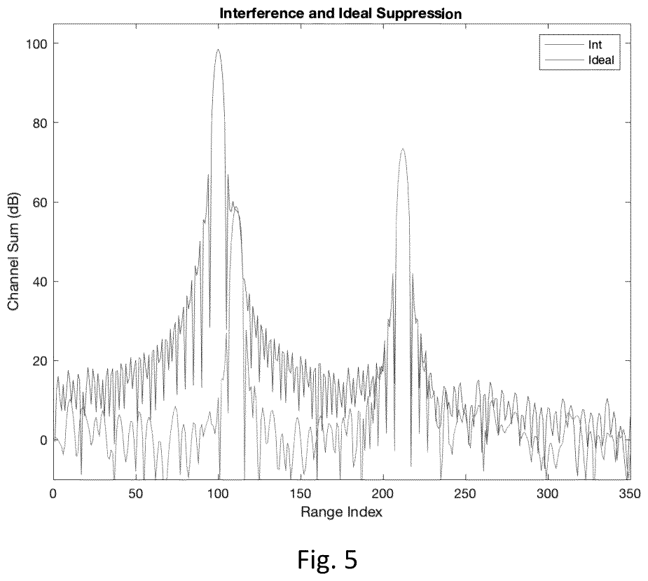

To provide a basic and controlled demonstration of the potential use of the GSPF on objects reflecting waveforms in the environment, a simple simulation has been performed. In this simulation there is a single cycle of a full polarimetric reading with a LFM transmit wave. There are three targets at range indices 100, 111, and 212. The object at range index 100 is sufficiently large to impede detection of the object at index 111. The simulation results as the sum of all available channels over ranges are plotted in FIGS. 5-12.

FIG. 5 is a simulation result of an environment with and without a masking object at index 100. In this figure, there are two traces. One has all three reflectors with the object at index 111 masked by the object at index 100. The other trace shows an ideal suppression where the reading is taken with the object at index 100 absent from the environment. Since the goal is to suppress the target at index 100 to increase the detectability of the object at index 111 the second trace represents ideal performance. Also the target at index 212 has a scattering matrix distinct from the other two. The utility of having this third target present is to show the effect of filtering on other arbitrary targets present in the environment.

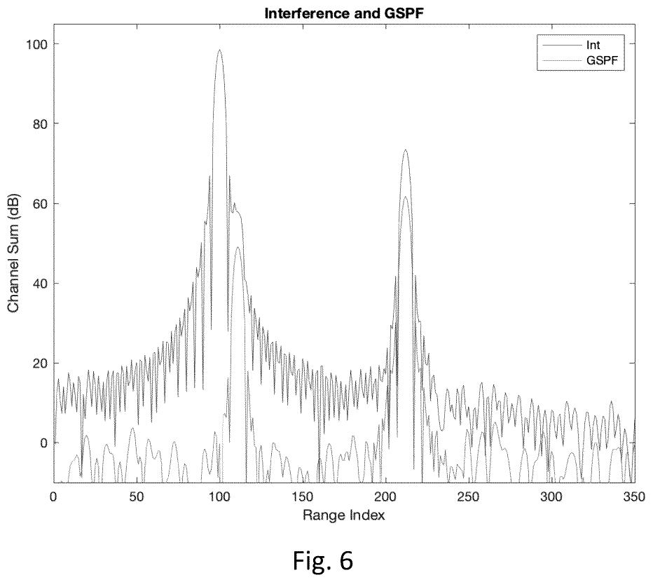

FIG. 6 is a simulation result of an environment with and without GSPF applied at index 100. To remove the masking target at index 100 the readings at the index were taken from the four matched filter outputs. These readings were then used to form a GSPF. The filter is then applied, and the results can be seen in a second trace of FIG. 2. As shown in FIG. 2, the GSPF filter is very effective at removing the target at index 100 and has made the target at index 111 easily detectable. There is, however, some attenuation to the targets remaining.

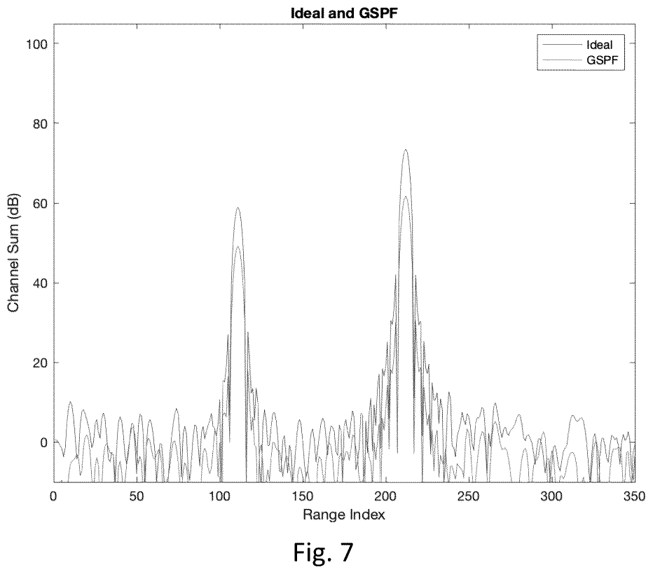

FIG. 7 shows a simulation comparing a GSPF result with an ideal result. In this figure the unwanted attenuation of the targets can be seen when the output of the GSPF is compared to the ideal situation where the target at index 100 is removed from the environment before the transmission. That is what the output would look like if the target at index 100 was physically removed.

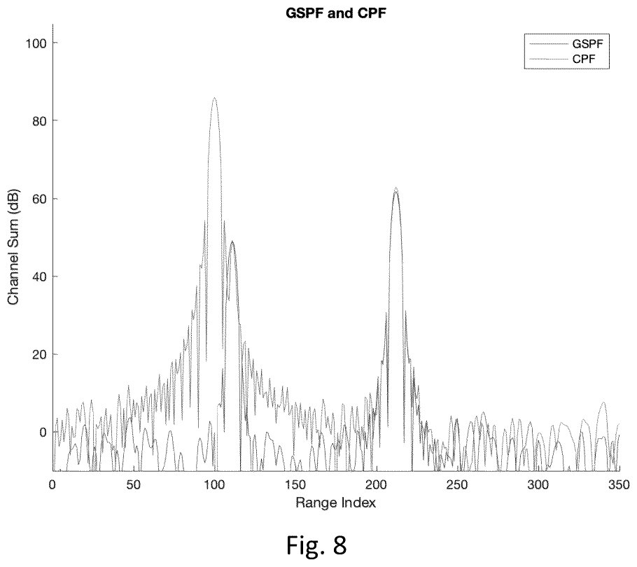

FIG. 8 shows a simulation comparing GSPF and CPF results. In this figure, the output of the summed GSPF channels is compared with the sum of the two independent CPF applications.

Another scenario to illustrate a different aspect of GSPF can be simulated. The environment is the same, but now there is another masking target of equal magnitude to that of the one at index 100, but this target is at the opposite side of the masked target at index 111, at index 122. The reference target has also been moved to index 223. This is a situation requiring two nulls which the SNPF is incapable of. Further this time prior knowledge of the scattering matrices of the masking is assumed. This demonstrates utility from recovering polarimetric information from sources other than matched filter outputs.

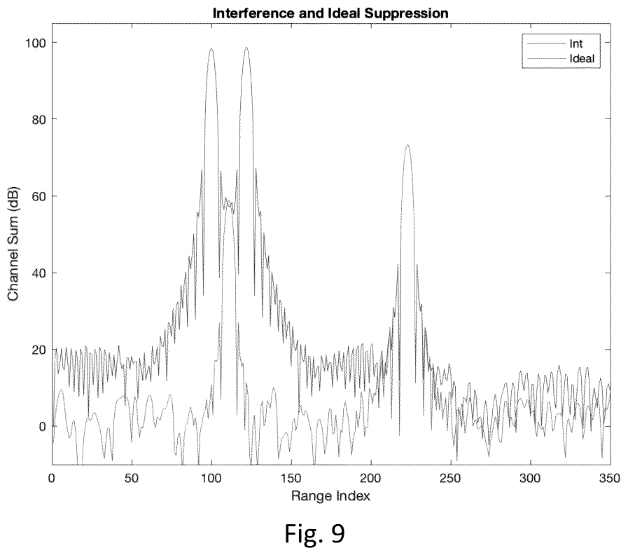

FIG. 9 shows a simulation of an environment with or without masking object at index 100 and 122. Without the masking object provides an ideal visibility. With the masking object, the interference overwhelms the ideal return as shown in FIG. 9.

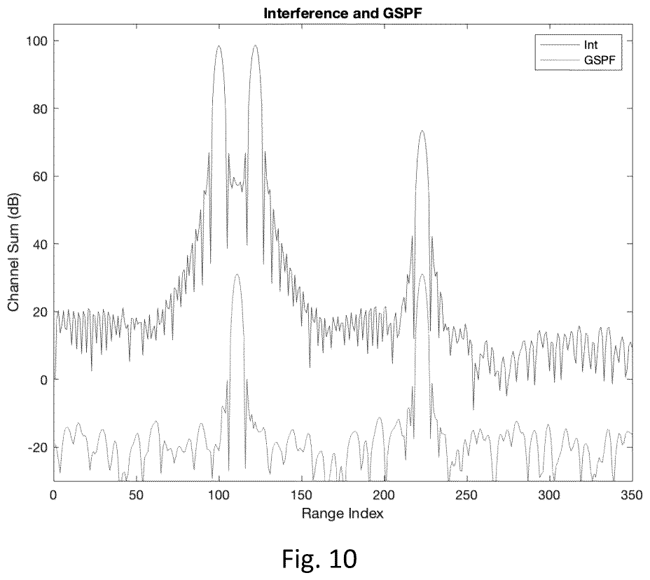

FIG. 10 shows a simulation of an environment with object at index 100 and 122 and with GSPF filtering. Here the GSPF filtering is applied with foreknowledge of the masking targets' scattering matrices. As shown in FIG. 10, the GSPF filtered result is significantly lower than the interference.

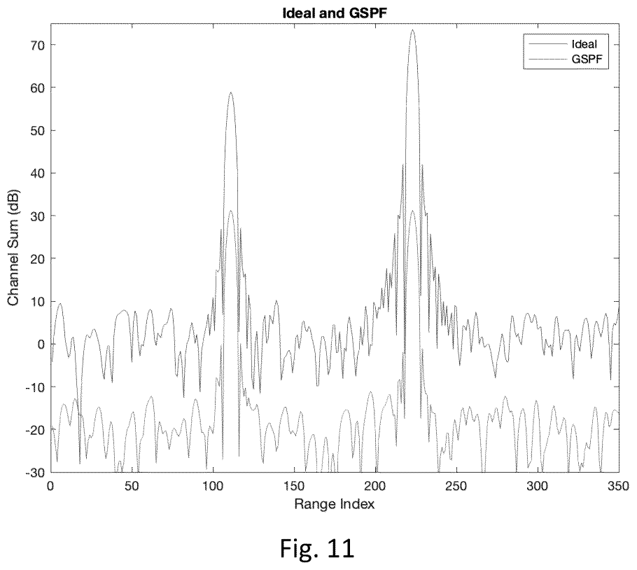

FIG. 11 shows a simulation of an environment without object at index 100 and 122 and with GSPF filtering.

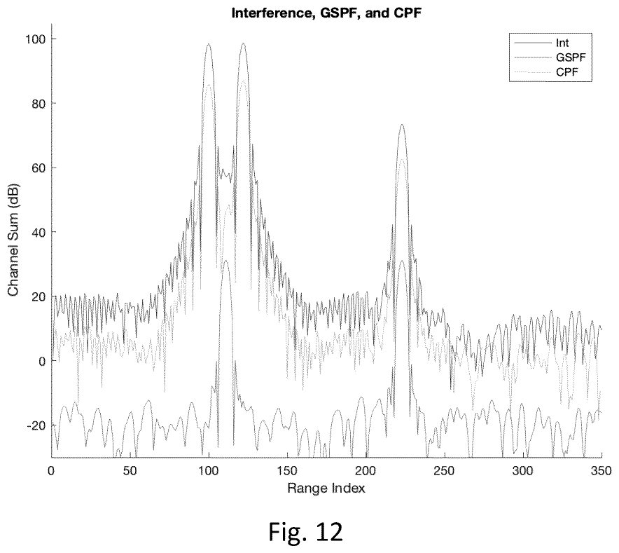

FIG. 12 shows a simulation of an environment without object at index 100 and 122 and with a comparison between CPF and GSPF filtering. This figure shows the application of the CPF with foreknowledge of the polarization. The unfiltered and GSPF traces are present for comparison. To compare basic approaches, a single of the polarizations must be chose to apply the CPF. In this case the leading, index 100, polarization was chosen.

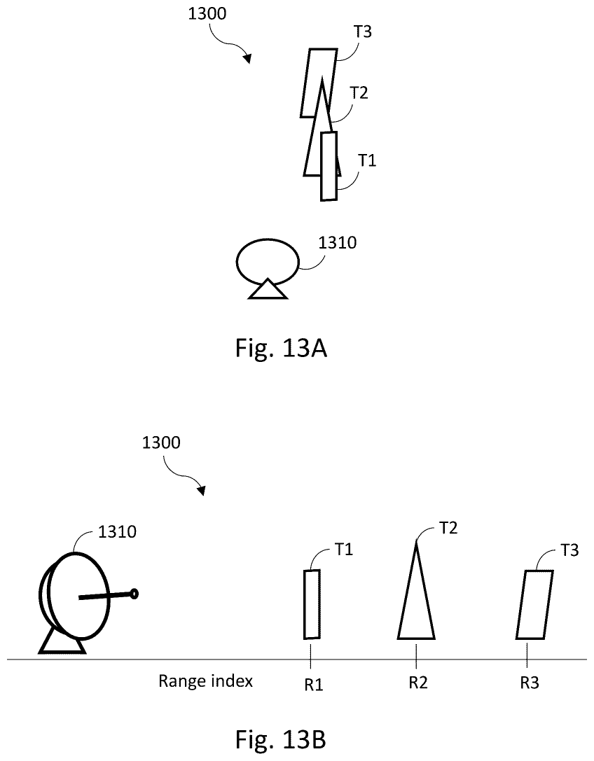

FIGS. 13A and 13B illustrate an experimental radar system 1300 for demonstrating the capability of a four-dimensional GSPF.

Referring to FIG. 13A, three targets, T1, T2, and T3, are placed in approximately a straight line in front of a radar 1310. The radar 1310 uses a continuous wave LFM sampled at 125 MHz with a band width of 100 KHz. When viewed from radar 1310, target T1 is the closest and partially blocks target T2 and T3. Target T2 is in the middle and partially blocks T3. Radar echo from target T3 will be obfuscated by targets T2 and T1; radar echo from target T2 will be obfuscated by target T1.

Referring to FIG. 13B, targets T1, T2 and T3 are placed at range indices R1, R2 and R3, respectfully. Range index R2 is larger than range index R1 but smaller than range index R3. Measurements were taken with all different combinations of these targets. Measurements with targets alone provide prior polarization information that can be used to form polarization filters.

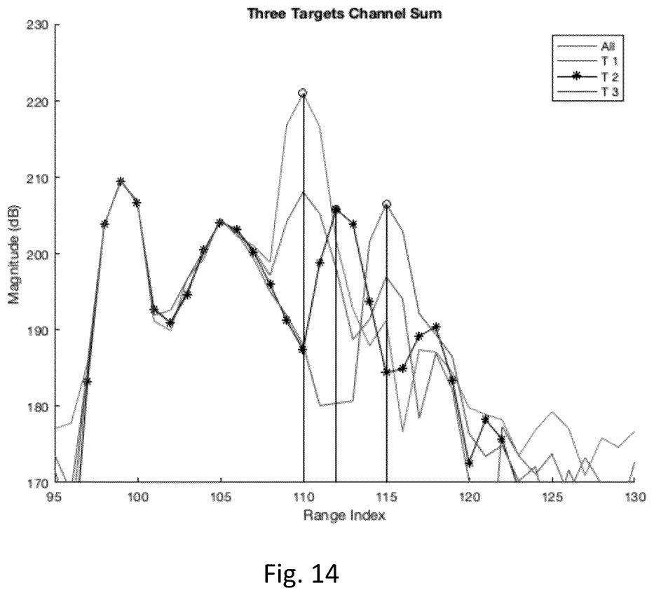

FIG. 14 shows measurements with the presents of all the targets or each target individually. The traces are a sum of all for polarization channels from a single full polarization reading of two LFM cycles. Markers have been placed to indicate true positions of targets T1, T2 and T3. As shown in FIG. 14, when all targets T1, T2, and T3 are present, target T2 which is located in the middle, becomes completely undetectable. It is noted that when all targets are present targets T1 and T3 are still detectable, with target T1 producing most of the masking interference.

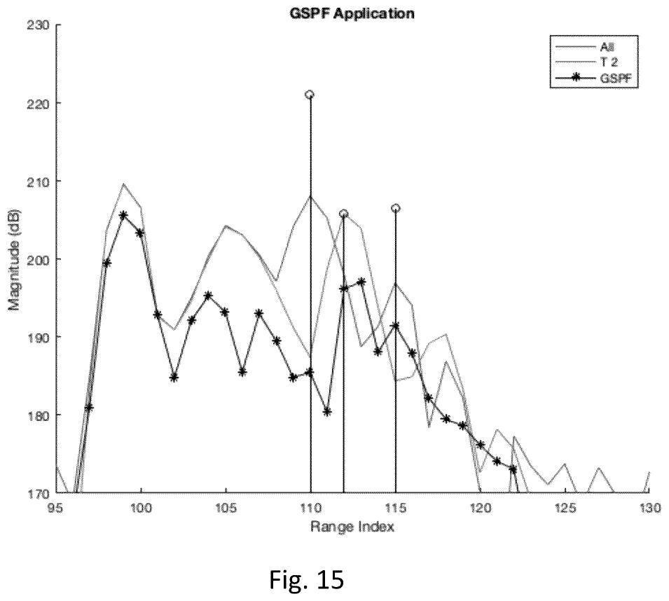

FIG. 15 shows measurements of all the targets with a GSPF applied to reveal target T2. In these measurements, a polarization of target T1 was measured using matched filter outputs when target T1 alone is present in the radar system 1300. This polarization finding was used to form a four-dimensional GSPF which is then used on a single full polarization reading from all three targes, T1, T2 and T3. The resulting channel sums can be seen in FIG. 15 with target T2 revealed.

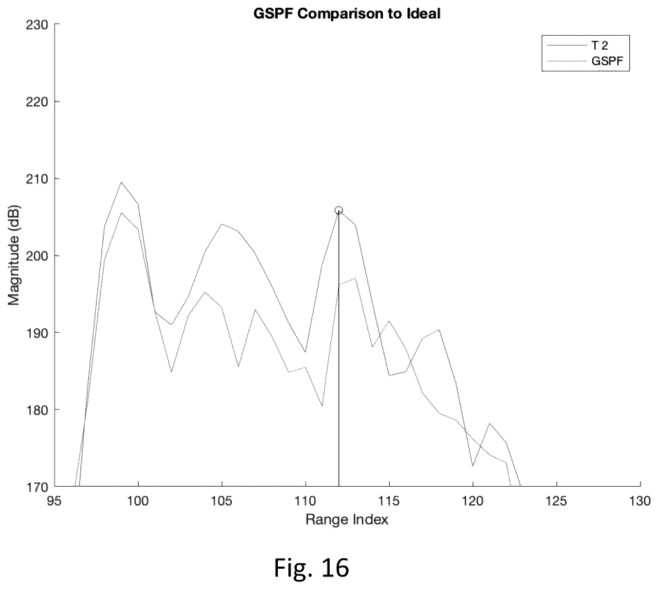

FIG. 16 shows a comparison between the GSPF measurement and an ideal measurement. A measurement of target T2 alone represents an ideal measurement which is compared with GSPF measurement depicted in FIG. 15. The comparison as shown in FIG. 16 reveals an attenuation due to the polarization filter, but target T2 becomes plainly visible as is desired.

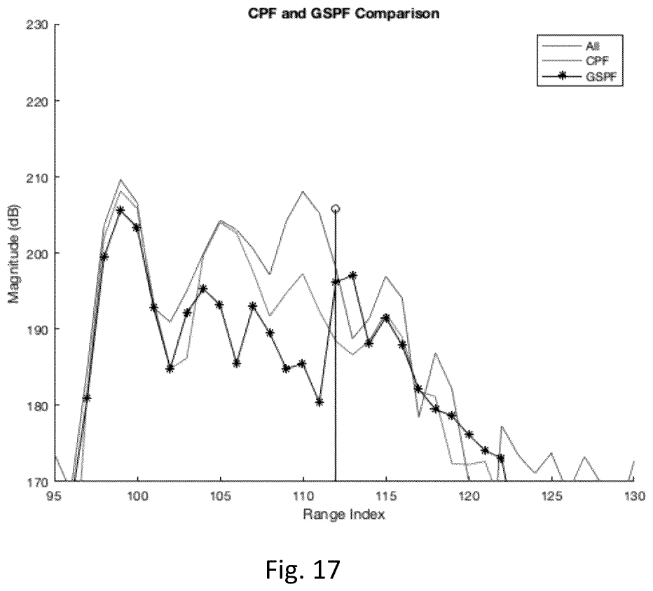

FIG. 17 shows a comparison between the GSPF measurement and a CPF measurement. Using prior knowledge of target T1's full polarization, an alternative approach is to use two two-dimensional conventional polarization filters (CPF). As shown in FIG. 17, a sum of the two CPFs is compared to the application of a four-dimensional GSPF depicted in FIG. 15. This demonstrates a utility of using four dimensions in a single filter with real world data.

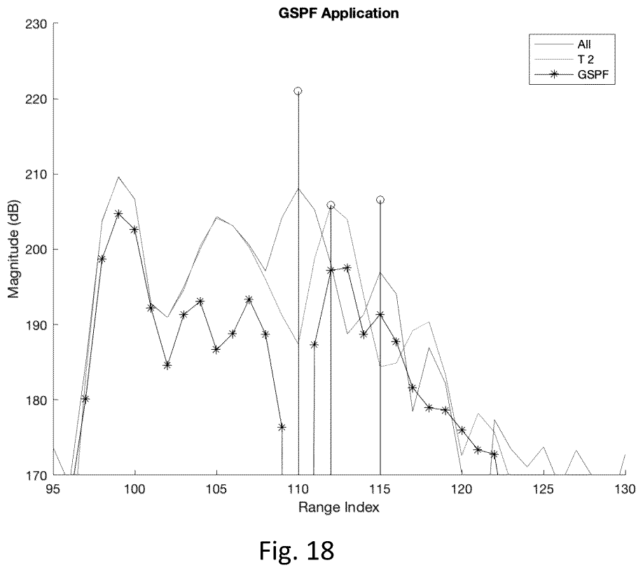

FIG. 18 shows a comparison between another GSPF measurement and the ideal measurement. This GSPF measurement is performed using direct polarization findings from the matched filter output without using prior polarization information. The GSPF formation and application are all done using a single reading. The results are degraded as compared to forming GSPF with prior polarization information of target T2 as depicted in FIG. 15, however, these results still produce detectability for target T2. This is another advantage of using four dimensional polarization.

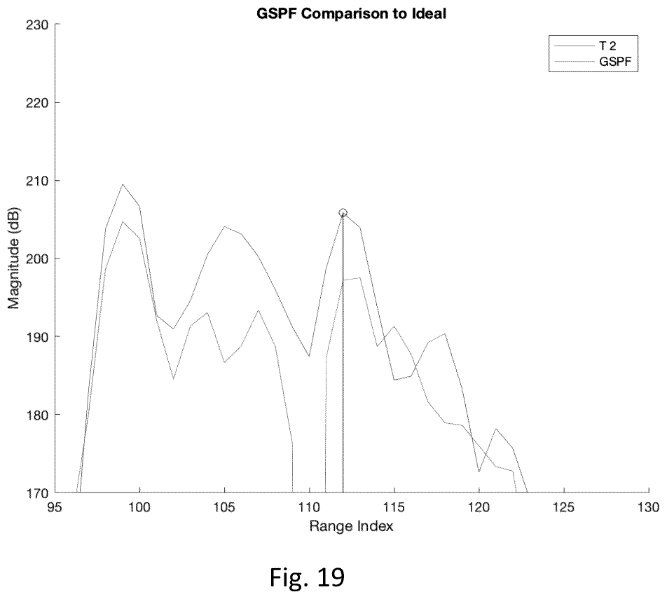

FIG. 19 shows a comparison between the GSPF measurement using no prior polarization knowledge and the ideal target T2 measurement. Again, the GSPF was formed from direct readings in the same matched filter outputs without prior polarization knowledge of target T1. The GSPF was then applied the radar returns with all targets present. The ideal target T2 measurement is performed with target T2 alone in the radar system 1300.

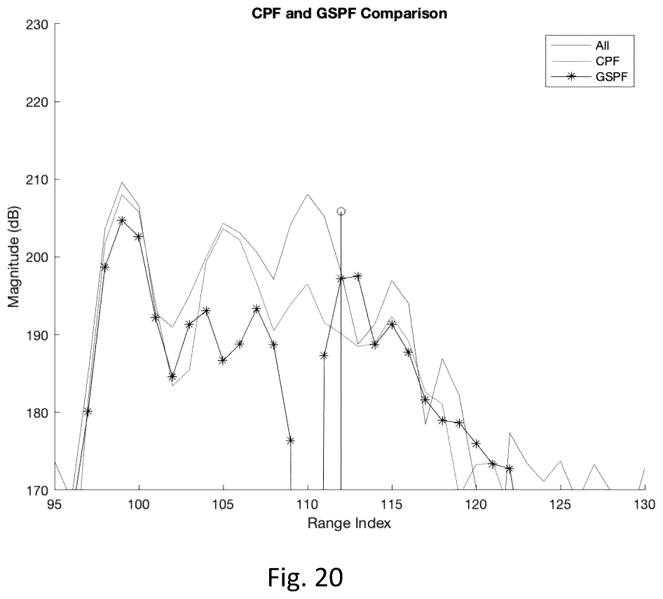

FIG. 20 shows a comparison between GSPF and CPFs results both without using prior polarization knowledge. Two conventional polarization filters (CPFs) can also be formed from direct readings in the same matched filter outputs without prior polarization knowledge of target T1.

The above simulations and real world radar measurements demonstrate that full polarized readings are possible with dual polarized radar systems. This mode of operation provides the opportunity for more polarimetric information, but in many cases will require appropriate filtering methods to take full advantage of the situation. The Gram Schmidt process provides a straightforward method to implement basic filtering in four dimensional full polarization returns. This new framework also provides new opportunities in the use of polarization filters. First the potential for ideal nulls is increased from one to three. Second the lower relative portion of a signal removed with a four dimensional filter as opposed to a two dimensional filter makes taking and using polarizations directly from matched filter outputs much more practical.

Some portions of the detailed descriptions of this disclosure have been presented in terms of procedures, logic blocks, processing, and other symbolic representations of operations on data bits within a computer or digital system memory. These descriptions and representations are the means used by those skilled in the data processing arts to most effectively convey the substance of their work to others skilled in the art. A procedure, logic block, process, etc., is herein, and generally, conceived to be a self-consistent sequence of steps or instructions leading to a desired result. The steps are those requiring physical manipulations of physical quantities. Usually, though not necessarily, these physical manipulations take the form of electrical or magnetic data capable of being stored, transferred, combined, compared, and otherwise manipulated in a computer system or similar electronic computing device. For reasons of convenience, and with reference to common usage, such data is referred to as bits, values, elements, symbols, characters, terms, numbers, or the like, with reference to various presently disclosed embodiments.

It should be borne in mind, however, that these terms are to be interpreted as referencing physical manipulations and quantities and are merely convenient labels that should be interpreted further in view of terms commonly used in the art. Unless specifically stated otherwise, as apparent from the discussion herein, it is understood that throughout discussions of the present embodiment, discussions utilizing terms such as “determining” or “outputting” or “transmitting” or “recording” or “locating” or “storing” or “displaying” or “receiving” or “recognizing” or “utilizing” or “generating” or “providing” or “accessing” or “checking” or “notifying” or “delivering” or the like, refer to the action and processes of a computer system, or similar electronic computing device, that manipulates and transforms data. The data is represented as physical (electronic) quantities within the computer system's registers and memories and is transformed into other data similarly represented as physical quantities within the computer system memories or registers, or other such information storage, transmission, or display devices as described herein or otherwise understood to one of ordinary skill in the art.

We claim:

1. An apparatus for detecting targets with radar signals, the apparatus comprising:
a receiver configured to receive a radar signal and generate a first return vector having four elements representing four channels of a full-polarimetric radar reading; and
a four-dimensional polarization filter applied to the first return vector, the four-dimensional polarization filter configured to arrange the first return vector in a column of four elements according to polarimetric components associated with of respective transmit/receive channels, take an inner product of a selected vector with the column, derive a projection coefficient by dividing the inner product by a magnitude of the selected vector, and produce an output by subtracting a product of the projection coefficient and the selected vector from the column.

2. The apparatus of claim 1, wherein the selected vector is estimated from an interference signal or clutters that impact detection performance.

3. The apparatus of claim 2, wherein the interference signal is identified from a second return vector different from the first return vector.

4. The apparatus of claim 2, wherein the interference signal is identified as undesired signal.

5. The apparatus of claim 1, wherein the column is indexed by either time or equivalently range.

6. The apparatus of claim 1, wherein the four channels include a HH channel for horizontal transmit and horizontal receive, a VV channel for vertical transmit and vertical receive, a HV channel for horizontal transmit and vertical receive and a VH channel for vertical transmit and horizontal receive.

7. The apparatus of claim 1, further comprising a transmitter configured to transmit orthogonally-polarized incident radar signals.

8. The apparatus of claim 7, wherein the receiver includes a matched filter configured to examine the received radar signal against the transmitted radar signals to generate the first return vector.

9. A system for detecting targets with radar signals, the system comprising:
a transmitter configured to transmit orthogonally-polarized incident radar signals;
a receiver configured to receive a radar signal and generate a first return vector having four elements representing four channels of a full-polarimetric radar reading; and
a four-dimensional polarization filter applied to the first return vector, the four-dimensional polarization filter configured to arrange the first return vector in a column of four elements according to polarimetric positions of respective channels, take an inner product of a selected vector with the column, derive a projection coefficient by dividing the inner product by a magnitude of the selected vector, and produce an output by subtracting a product of the projection coefficient and the selected vector from the column.

10. The system of claim 9, wherein the selected vector is estimated from an undesired interference signal identified from a second return vector different from the first return vector.

11. The system of claim 9, wherein the column is indexed by either time or range.

12. The system of claim 9, wherein the four channels include a HH channel for horizontal transmit and horizontal receive, a VV channel for vertical transmit and vertical receive, a HV channel for horizontal transmit and vertical receive and a VH channel for vertical transmit and horizontal receive.

13. The system of claim 9, wherein the receiver includes a matched filter configured to examine the received radar signal against the transmitted radar signals to generate the first return vector.

14. A method for detecting targets with radar signals, the method comprising:
receiving a radar signal by a receiver to generate a first return vector having four elements representing four channels of a full-polarimetric radar reading; and
filtering the first return vector by a four-dimensional polarization filter, the filtering including arranging the first return vector in a column of four elements according to polarimetric positions of respective channels, taking an inner product of a selected vector with the column, deriving a projection coefficient by dividing the inner product by a magnitude of the selected vector, and producing an output by subtracting a product of the projection coefficient and the selected vector from the column.

15. The method of claim 14, wherein the selected vector is estimated from an undesired interference signal.

16. The method of claim 15, wherein the interference signal is identified from a second return vector different from the first return vector.

17. The method of claim 14, wherein the column is indexed by either time or range.

18. The method of claim 14, wherein the four channels include a HH channel for horizontal transmit and horizontal receive, a VV channel for vertical transmit and vertical receive, a HV channel for horizontal transmit and vertical receive and a VH channel for vertical transmit and horizontal receive.

19. The method of claim 14, further comprising transmitting orthogonally-polarized incident radar signals by a transmitter.

20. The method of claim 19, further comprising examining, by a matched filter, the received radar signal against the transmitted radar signals to generate the first return vector.
